(19) United States
(12) Patent Application Publication
(10) Pub. No.: US 2015/0235416 A1
(43) Pub. Date: Aug. 20, 2015

(54) SYSTEMS AND METHODS FOR GENTERATING A 3-D MODEL OF A VIRTUAL TRY-ON PRODUCT

(71) Applicant: GLASSES.COM LLC, Draper, UT (US)

(72) Inventors: Jonathan Coon, Austin, TX (US); Adam Gravois, Austin, TX (US); Ryan Engle, Pflugerville, TX (US); Darren Turetzky, Cedar Park, TX (US)

(21) Appl. No.: 14/697,622

(22) Filed: Apr. 28, 2015

Related U.S. Application Data
(63) Continuation of application No. 13/837,039, filed on Mar. 15, 2013, now abandoned.
(60) Provisional application No. 61/650,983, filed on May 23, 2012.
(60) Provisional application No. 61/735,951, filed on Dec. 11, 2012.

(51) Int. Cl. G06T 17/20; G06T 15/04; G06Q 30/06; G06T 19/20

(52) U.S. Cl. CPC G06T 17/20; G06T 19/20; G06T 15/04; G06Q 30/0643; G06T 2219/2021; G06T 2219/2024

(57) ABSTRACT

A computer-implemented method for generating a three-dimensional (3-D) model of a virtual try-on product. At least a portion of an object is scanned. The object includes at least first and second surfaces. An aspect of the first surface is detected. An aspect of the second surface is detected, the aspect of the second surface being different from the aspect of the first surface. A polygon mesh of the first and second surfaces is generated from the scan of the object.

### RELATED APPLICATIONS

This application is a Continuation of U.S. patent application Ser. No. 13/837,039 entitled SYSTEMS AND METHODS FOR GENERATING A 3-D MODEL OF A VIRTUAL TRY-ON PRODUCT, filed on Mar. 15, 2013; which application claims priority to U.S. Provisional Application No. 61/650,983, entitled SYSTEMS AND METHODS TO VIRTUALLY TRY-ON PRODUCTS, filed on May 23, 2012; and U.S. Provisional Application No. 61/735,951, entitled SYSTEMS AND METHODS TO VIRTUALLY TRY-ON PRODUCTS, filed on Dec. 11, 2012, which is incorporated herein in its entirety by this reference.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computers have opened up an entire industry of internet shopping. In many ways, online shopping has changed the way consumers purchase products. For example, a consumer may want to know what they will look like in and/or with a product. On the webpage of a certain product, a photograph of a model with the particular product may be shown. However, users may want to see more accurate depictions of themselves in relation to various products.

### SUMMARY

According to at least one embodiment, a computer-implemented method for generating a virtual try-on product is described. At least a portion of an object may be scanned. The object may include at least first and second surfaces. An aspect of the first surface may be detected. An aspect of the second surface may be detected. The aspect of the first surface may be different from the aspect of the second surface. A polygon mesh of the first and second surfaces may be generated from the scan of the object

In one embodiment, the polygon mesh may be positioned in relation to a 3-D fitting object in a virtual 3-D space. The shape and size of the 3-D fitting object may be predetermined. At least one point of intersection may be determined between the polygon mesh and the 3-D fitting object.

In some configurations, the object may be scanned at a plurality of predetermined viewing angles. The polygon mesh may be rendered at the predetermined viewing angles. One or more vertices of the polygon mesh corresponding to the first surface may be modified to simulate the first surface. Modifying the one or more vertices of the polygon mesh of the first surface may include adding a plurality of vertices to at least a portion of the polygon mesh corresponding to the first surface. A decimation algorithm may be performed on at least a portion of the polygon mesh corresponding to the second surface.

In some embodiments, at least one symmetrical aspect of the object may be determined. Upon determining the symmetrical aspect of the object, a portion of the object may be scanned based on the determined symmetrical aspect. The result of scanning the object may be mirrored in order to generate a portion of the polygon mesh that corresponds to a portion of the object not scanned. A texture map may be generated from the scan of the object. The texture map may include a plurality of images depicting the first and second surfaces of the object. The texture map may map a two-dimensional (2-D) coordinate of one of the plurality of images depicting the first and second surfaces of the object to a 3-D coordinate of the generated polygon mesh of the object.

A computing device configured to generate a virtual try-on product is also described. The device may include a processor and memory in electronic communication with the processor. The memory may store instructions that are executable by the processor to scan at least a portion of an object, wherein the object includes at least first and second surfaces, detect an aspect of the first surface, and detect an aspect of the second surface. The second aspect may be different from the first aspect. The instructions may be executable by the processor to generate a polygon mesh of the first and second surfaces from the scan of the object.

A computer-program product to generate a virtual try-on product is also described. The computer-program product may include a non-transitory computer-readable medium that stores instructions. The instructions may be executable by a processor to scan at least a portion of an object, wherein the object includes at least first and second surfaces, detect an aspect of the first surface, and detect an aspect of the second surface. The second aspect may be different from the first aspect. The instructions may be executable by the processor to generate a polygon mesh of the first and second surfaces from the scan of the object.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a model generator;

FIG. 4 is a block diagram illustrating one example of a polygon mesh module;

FIG. 5 illustrates an example arrangement for scanning an object;

FIG. 6 illustrates an example arrangement of a virtual 3-D space;

FIG. 7 illustrates an example arrangement for capturing an image of a user;

FIG. 8 is a diagram illustrating an example of a device for capturing an image of a user;

FIG. 9 illustrates an example arrangement of a virtual 3-D space including a depiction of a 3-D model of a user;

FIG. 10 illustrates another example arrangement of a virtual 3-D space;

FIG. 11 is a flow diagram illustrating one embodiment of a method for generating a 3-D model of an object;

FIG. 12 is a flow diagram illustrating one embodiment of a method for rendering a polygon mesh;

FIG. 13 is a flow diagram illustrating one embodiment of a method for scanning an object based on a detected symmetry of the object; and

FIG. 14 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to the virtually trying-on of products. Three-dimensional (3-D) computer graphics are graphics that use a 3-D representation of geometric data that is stored in the computer for the purposes of performing calculations and rendering two-dimensional (2-D) images. Such images may be stored for viewing later or displayed in real-time. A 3-D space may include a mathematical representation of a 3-D surface of an object. A 3-D model may be contained within a graphical data file. A 3-D model may represent a 3-D object using a collection of points in 3-D space, connected by various geometric entities such as triangles, lines, curved surfaces, etc. Being a collection of data (points and other information), 3-D models may be created by hand, algorithmically (procedural modeling), or scanned such as with a laser scanner. A 3-D model may be displayed visually as a two-dimensional image through rendering, or used in non-graphical computer simulations and calculations. In some cases, the 3-D model may be physically created using a 3-D printing device.

A device may capture an image of the user and generate a 3-D model of the user from the image. A 3-D polygon mesh of an object may be placed in relation to the 3-D model of the user to create a 3-D virtual depiction of the user wearing the object (e.g., a pair of glasses, a hat, a shirt, a belt, etc.). This 3-D scene may then be rendered into a 2-D image to provide the user a virtual depiction of the user in relation to the object. Although some of the examples used herein describe articles of clothing, specifically a virtual try-on pair of glasses, it is understood that the systems and methods described herein may be used to virtually try-on a wide variety of products. Examples of such products may include glasses, clothing, foot-wear, jewelry, accessories, hair styles, etc.

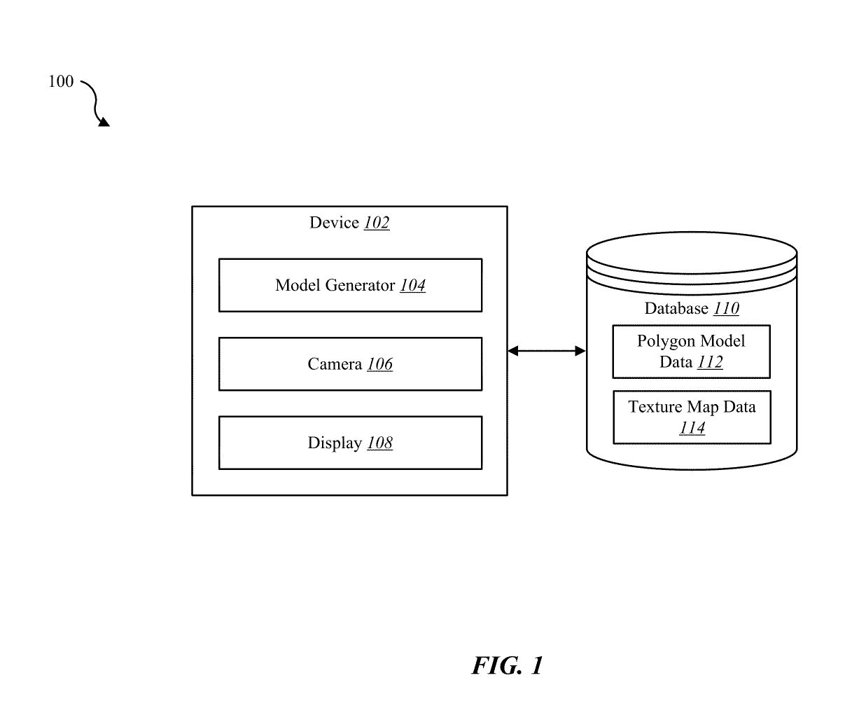

FIG. 1 is a block diagram illustrating one embodiment of an environment 100 in which the present systems and methods may be implemented. In some embodiments, the systems and methods described herein may be performed on a single device (e.g., device 102). For example, a model generator 104 may be located on the device 102. Examples of devices 102 include mobile devices, smart phones, personal computing devices, computers, servers, etc.

In some configurations, a device 102 may include a model generator 104, a camera 106, and a display 108. In one example, the device 102 may be coupled to a database 110. In one embodiment, the database 110 may be internal to the device 102. In another embodiment, the database 110 may be external to the device 102. In some configurations, the database 110 may include polygon model data 112 and texture map data 114.

In one embodiment, the model generator 104 may initiate a process to generate a 3-D model of an object. As described above, the object may be a pair of glasses, an article of clothing, footwear, jewelry, an accessory, or a hair style. Additionally, or alternatively, the object may be a user of the device 102 or a portion of the user such as the user's head, torso, hand, arm, leg, foot, etc. In some configurations, the model generator 104 may obtain multiple images of the object. For example, the model generator 104 may capture multiple images of an object via the camera 106. For instance, the model generator 104 may capture a video (e.g., a 5 second video) via the camera 106. In some configurations, the model generator 104 may use polygon model data 112 and texture map data 114 to generate a 3-D representation of the scanned object. For example, the polygon model data 112 may include vertex coordinates of a polygon model of a pair of glasses. In some embodiments, the model generator 104 may use color information from the pixels of multiple images of the object to create a texture map of the object. In some embodiments, the polygon model data 112 may include a polygon model of an object. In some configurations, the texture map data 114 may define a visual aspect of the 3-D model of the object such as color, texture, shadow, and/or transparency.

In some configurations, the model generator 104 may generate a virtual try-on image by rendering a virtual 3-D space that contains a 3-D model of a user in relation to a 3-D model of a product (e.g., 3-D model of a pair of glasses). In one example, the virtual try-on image may illustrate the user with a rendered version of the product. In some configurations, the model generator 104 may output the virtual try-on image to the display 108 to be displayed to a user. In some embodiments, the model generator 104 may analyze a 2-D image of an object in relation to analysis of a 2-D image of a user. Based on the analysis of each image, the model generator 104 may alter the 2-D image of an object based on features of a user detected in the 2-D image of the user. The model generator 104 may overlay the altered 2-D image of the object over the 2-D image of the user to generate an image that makes the user appear to be wearing the object.

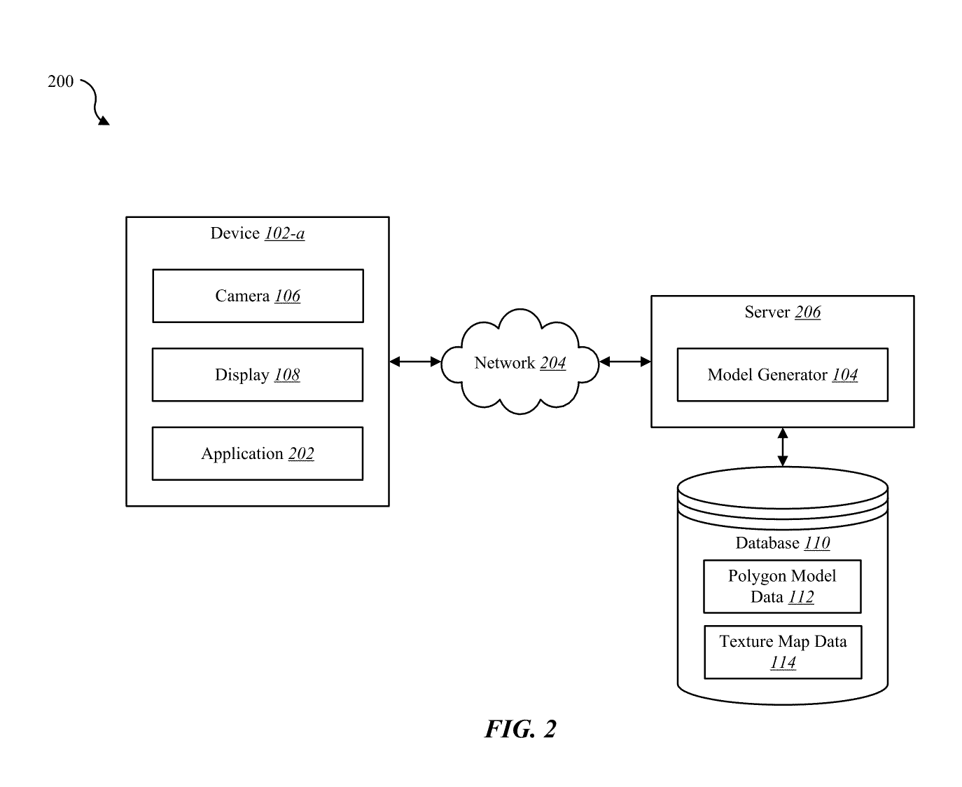

FIG. 2 is a block diagram illustrating another embodiment of an environment 200 in which the present systems and methods may be implemented. In some embodiments, a device 102-a may communicate with a server 206 via a network 204. Example of networks 204 include, local area networks (LAN), wide area networks (WAN), virtual private networks (VPN), wireless local area networks (WLAN), cellular networks (using 3G and/or LTE, for example), etc. In some configurations, the network 204 may include the internet. In some configurations, the device 102-a may be one example of the device 102 illustrated in FIG. 1. For example, the device 102-a may include the camera 106, the display 108, and an application 202. It is noted that in some embodiments, the device 102-a may not include a model generator 104. In some embodiments, both a device 102-a and a server 206 may include a model generator 104 where at least a portion of the functions of the model generator 104 are performed separately and/or concurrently on both the device 102-a and the server 206.

In some embodiments, the server 206 may include the model generator 104 and may be coupled to the database 110. For example, the model generator 104 may access the polygon model data 112 and the texture map data 114 in the database 110 via the server 206. The database 110 may be internal or external to the server 206.

In some configurations, the application 202 may capture multiple images via the camera 106. For example, the application 202 may use the camera 106 to capture a video. Upon capturing the multiple images, the application 202 may process the multiple images to generate result data. In some embodiments, the application 202 may transmit the multiple images to the server 206. Additionally or alternatively, the application 202 may transmit to the server 206 the result data or at least one file associated with the result data.

In some configurations, the model generator 104 may process multiple images of an object to generate a 3-D model of the object. The model generator 104 may render a 3-D space that includes the 3-D model of a user and the 3-D polygon model of the object to render a virtual try-on 2-D image of the object and the user. The application 202 may output a display of the user to the display 108 while the camera 106 captures an image of the user.

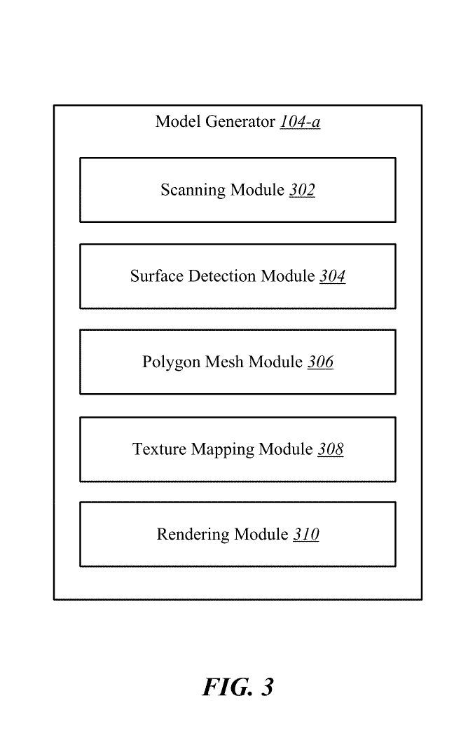

FIG. 3 is a block diagram illustrating one example of a model generator 104-a. The model generator 104-a may be one example of the model generator 104 depicted in FIGS. 1 and/or 2. As depicted, the model generator 104-a may include a scanning module 302, a surface detection module 304, a polygon mesh module 306, a texture mapping module 308, and a rendering module 310.

In some configurations, the scanning module 302 may obtain a plurality of images of an object (e.g., an article of clothing, a pair of sunglasses, a user's face, etc.). In some embodiments, the scanning module 302 may activate the camera 106 to capture at least one image of the object. Additionally, or alternatively, the scanning module 302 may capture a video of the object. In one embodiment, the scanning module 302 may include a laser to scan the object. In some configurations, the scanning module 302 may use structured light to scan the object. The scanning module 302 may scan at least a portion of the object. The object may include two or more distinguishable surfaces. In some embodiments, the scanning module 302 may scan the object at a plurality of predetermined viewing angles. In some embodiments, the scanning module 302 may capture one or more images of a user facing one or more angles. For example, the scanning module 302, via the camera 106, may capture a video of a user. From the video of the user, the scanning module 302 may extract one or more images of the user.

In one embodiment, the scanning module 302 may capture an image of the user holding an object of known size in order to determine a scale of one or more images of the user. For example, the scanning module 302 may capture an image of the user holding a card (e.g., credit card, membership card, driver license, etc.). In some embodiments, the scanning module 302 may capture an image of the user holding a card to the user's forehead. In some embodiments, the scanning module 302 may feed a real-time image of the user from a camera (e.g., an image captured from camera 106) on a display (e.g., display 108) to provide a visual feedback of the position of the user in relation to the camera's field of view.

In some embodiments, the scanning module 302 may display a head-position guide. The head-position guide may be graphical in nature. The head-position guide, together with the real-time feedback image of the user, may provide an on-screen, visual feedback to the user as to how the user's face should be positioned in relation to the camera's field of view. For example, the head-position guide may include a circular display object (e.g., a circle, oval, almond, or other similar head-shaped display object) on the display. The scanning module 302 may provide an instruction (e.g., written text instruction, audio instruction, etc.) to the user to center the user's face within the circular display object of the head-position guide.

In some embodiments, the scanning module 302 may display a head-rotation guide. The head-rotation guide may be graphical in nature. The head-rotation guide may provide a visual feedback to the user as to how the user's face should be rotated in relation to the camera's field of view. For example, the head-rotation guide may instruct the user to rotate the user's head to the left of facing the camera, to the right of facing the camera, and/or to the center (i.e., facing the camera), etc. In some embodiments, the head-rotation guide may instruct the user to rotate the camera to the left of the user's face, to the right of the user's face, and to the center of the user's face. Additionally, or alternatively, the head-rotation guide may include an on-screen rotation cursor on the display. The rotation cursor may move across the display as a visual feedback to the user as the user rotates his or her head. The rotation cursor may move toward to one side of the display at a predetermined speed in order to provide feedback to the user of both the direction in which to rotate the user's head as well as the speed at which the user is to rotate the user's head.

In one embodiment, the surface detection module 304 may detect one or more surfaces on the object being scanned. One or more surfaces on the object may have certain characteristics. For example, the object may have a surface that is glossy or shiny, a surface that is transparent, and/or a surface that is matte. For instance, from a scan of a pair of glasses the surface detection module 304 may detect a surface on the glasses corresponding to a lens, and detect a surface on the glasses corresponding to a portion of the frame. Thus, the surface detection module 304 may detect characteristics, or aspects, of two or more surfaces on the object where each characteristic is different from one or more characteristics of other surfaces.

In one embodiment, the surface detection module 304 may detect one or more data points of the user from the one or more captured images of the user. The surface detection module 304 may analyze the one or more data points of the user. Based on the analysis of the one or more data points of the user, the surface detection module 304 may detect one or more features of the user's head and/or face. In some configurations, the surface detection module 304 may examine a pixel (i.e., one embodiment of a data point) of an image to determine whether the pixel includes a feature of interest. In some embodiments, the surface detection module 304 detects a face and/or head of a user in an image of the user. In some embodiments, the surface detection module 304 detects features of the user's head and/or face. In some embodiments, the surface detection module 304 may detect an edge, corner, interest point, blob, and/or ridge in an image of an object. An edge may be points of an image where there is a boundary (or an edge) between two image regions, or a set of points in the image which have a relatively strong gradient magnitude. Corners and interest points may be used interchangeably. An interest point may refer to a point-like feature in an image, which has a local two dimensional structure. In some embodiments, the surface detection module 304 may search for relatively high levels of curvature in an image gradient to detect an interest point and/or corner (e.g., corner of an eye, corner of a mouth). Thus, the surface detection module 304 may detect in an image of a user's face the corners of the eyes, eye centers, pupils, eye brows, point of the nose, nostrils, corners of the mouth, lips, center of the mouth, chin, ears, forehead, cheeks, and the like. A blob may include a complementary description of image structures in terms of regions, as opposed to corners that may be point-like in comparison. Thus, in some embodiments, the surface detection module 304 may detect a smooth, non-point-like area (i.e., blob) in an image. Additionally, or alternatively, in some embodiments, the surface detection module 304 may detect a ridge of points in the image. In some embodiments, the surface detection module 304 may extract a local image patch around a detected feature in order to track the feature in other images. In some embodiments, the surface detection module 304 may track the detected features of an object as it rotates (i.e., detect the change of a detected feature in a first picture of an object and the detected feature in a second picture of the object). For example, the surface detection module 304 may track a user's eyes, nose, mouth, and/or ears from one or more images of the user that show the user facing one or more different angles with relation to the camera that captured the images of the user.

In some configurations, from the scan of the object (e.g., pair of glasses, a user's face, etc.), the polygon mesh module 306 may generate a polygon mesh of each detected surface of the object. The texture mapping module 308 may be configured to generate a texture map from the scan of the object. The texture map may include a plurality of images depicting the first and second surfaces of the object. The texture map may correlate a two-dimensional (2-D) coordinate of one of the plurality of images depicting the first and second surfaces of the object to a 3-D coordinate of the generated polygon mesh of the object. Thus, in some configurations, the texture mapping module 308 may generate texture coordinate information associated with the determined 3-D structure of the object, where the texture coordinate information may relate a 2-D coordinate (e.g., UV coordinates) of an image of the object to a 3-D coordinate (e.g., XYZ coordinates) of the 3-D model of the object. In one configuration, the rendering module 310 may apply the texture map to the polygon mesh and render the polygon mesh at the predetermined viewing angles in relation to a plurality of images of a user.

In one embodiment, the model generator 104-a may overlay an image of the user over a polygon mesh of a user's face. Thus, in some configurations, the model generator 104-a may generate an individual, personalized polygon mesh of the user's face based on the one or more detected features of the user from the one or more images of the user. The model generator 104-a may match one or more images of the user with the 3-D model of the user. In one configuration, the model generator 104-a may match one or more images of the user to a one-model-fits-all polygon mesh of a universal face, where the universal, generic polygon mesh face is applied to images of all users. For example, a generic polygon mesh of a universally-applied 3-D model of a face may include a generic polygon mesh head, including a generic polygon mesh skeletal structure of the human head (i.e., polygon mesh skull, fore-head, cheek bone, jaw bone, eye sockets, ear structure, nose structure, etc.) Thus, the generic polygon mesh head may include generic polygon mesh ears, eyes, nose, mouth and lips, chin, etc. In some embodiments, the model generator 104-a matches the position and direction of a generic polygon mesh head relative to a 3-D space to a detected position and direction of a user's face in an image of the user (e.g., based on a detected camera point of view, detected by the model generator 104-a).

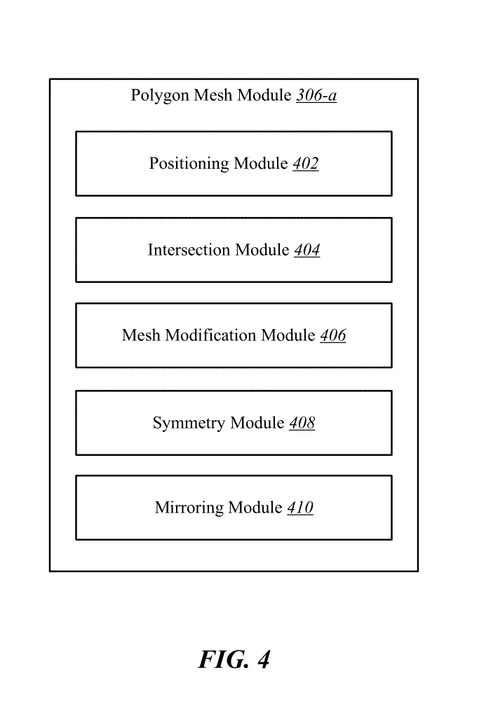

FIG. 4 is a block diagram illustrating one example of a polygon mesh module 306-a. The polygon mesh module 306-a may be one example of the image processor 304 illustrated in FIG. 3. As depicted, the polygon mesh module 306-a may include a positioning module 402, an intersection module 404, a mesh modification module 406, a symmetry module 408, and a mirroring module 410.

In one configuration, the positioning module 402 may position the polygon mesh in relation to a 3-D fitting object in a virtual 3-D space. The 3-D fitting object may include a predetermined shape and size. An example of the 3-D fitting object may include a universal 3-D model of a human head. For instance, a polygon mesh of a pair of glasses may be positioned in relation to a universal 3-D model of a human head in order to determine how to position the glasses on a realistic, scaled 3-D model of a user's head. In one embodiment, the intersection module 404 may determine at least one point of intersection between the polygon mesh and the 3-D fitting object. In one embodiment, the positioning module 402 may position a 3-D model of a pair of glasses on a 3-D model of a user, the 3-D models of the user and/or glasses generated from one or more images of the user and/or glasses, as described above. In some embodiments, the positioning module 402 may position a 3-D pair of glasses on a generic 3-D model of a user.

In some embodiments, the positioning module 402 may overlay an image of a user over the 3-D model of the user, and overlay the image of the user with a 3-D model of a pair of glasses, where the position of the glasses is based on the underlying 3-D model of the user. The model generator 104 may render this sequence as a 2-D image and display the rendered image on a display (e.g., display 108). In some configurations, the positioning module 402 may position a rendered pair of glasses on an image of the user based on the detected features of the user from the one or more images of the user facing one or more angles. In some embodiments, the positioning module 402 may employ augmented and/or mediated reality (e.g., an direct or indirect, view of a physical, real-world environment whose elements are augmented by computer-generated sensory input such as sound, video, graphics or GPS data) to display a pair of glasses on an image of the user. For example, the positioning module 402 may modify or augment an image of the user with a rendered pair of glasses overlaying the image of the user. Thus, the positioning module 402 may modify an image of the user not wearing a pair of glasses with a 2-D or 3-D image of a pair of glasses in order to make the user appear to be wearing the depicted pair of glasses.

In some configurations, the mesh modification module 406 may modify one or more vertices of the polygon mesh corresponding to one or more surfaces of the object in order to simulate a characteristic detected in a surface. For example, the surface corresponding to the lenses on a scanned pair of glasses may have a characteristic of being reflective, shiny, and/or transparent. The mesh modification module 406 may modify one or more 3-D points of data corresponding to the lenses in the polygon mesh of the glasses in order to better simulate the detected characteristics of reflectivity, shininess, and/or transparency detected from the scan of the glasses. In some configurations, the mesh modification module 406 may add one or more vertices to at least a portion of the polygon mesh corresponding to one of the surfaces of the scanned object. For example, the mesh modification module 406 may add one or more edge-loops to a region of the polygon mesh corresponding to a surface of the object in order to improve the visual simulation of that surface. In some configurations, the mesh modification module 406 may perform a decimation algorithm on at least a portion of the polygon mesh corresponding to one or more surfaces of the object. For example, because certain surfaces of an object when rendered may still appear realistic even when the number of vertices per given area are reduced, the mesh modification module 406 may reduce the number of vertices corresponding to one or more surfaces of the object. For instance, the mesh modification module 406 may reduce the number of vertices of a polygon mesh corresponding to at least a portion of the frames of a scanned pair of glasses.

In some embodiments, the symmetry module 408 may determine at least one symmetrical aspect of the object. For example, the symmetry module 408 may determine the left side of a pair of glasses is more or less symmetrical with the right side. Upon determining the symmetrical aspect of the object, the scanning module 302 may scan a portion of the object based on the determined symmetrical aspect. For example, the scanning module 302 may scan the left side of a pair of glasses, but not the right side. The polygon mesh module 306-a may generate a polygon mesh corresponding to the left side of the pair of glasses. In some configurations, the mirroring module 410 may mirror the result of scanning a symmetrical portion of the object in order to generate the portion of the polygon mesh that corresponds to a portion of the object not scanned. For example, the mirroring module 410 may mirror the generated polygon mesh of the left side of the pair of glasses in order to generate the polygon mesh of the right side of the pair of glasses. The polygon mesh module 306-a may merge the polygon meshes of left and right sides of the pair of glasses to generate a complete polygon mesh of the pair of glasses. Thus, the generated polygon mesh of an object may be positioned in relation to an image of a user in order to create a realistic rendered image of the user wearing and/or holding the object.

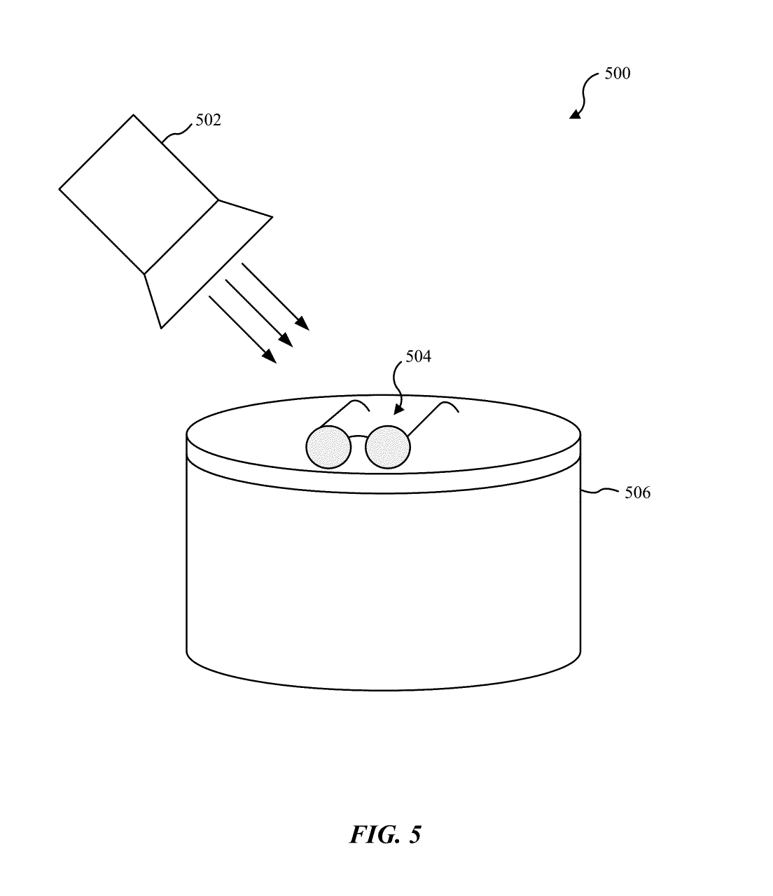

FIG. 5 illustrates an example arrangement 500 for scanning an object 504. In particular, the illustrated example arrangement 500 may include a scanner 502, an object 504, and a display stand 506.

As depicted, the object 504 (e.g., a pair of glasses) may be placed on a display stand 506. In one embodiment, the scanner may scan the object in association with the scanning module 302. For instance, the scanner 502 may use a laser to perform a laser scan of the object. The polygon mesh module 302 may generate a polygon mesh of the object from the laser scan of the object. Additionally, or alternatively, the scanner 502 may use structured light to scan the object.

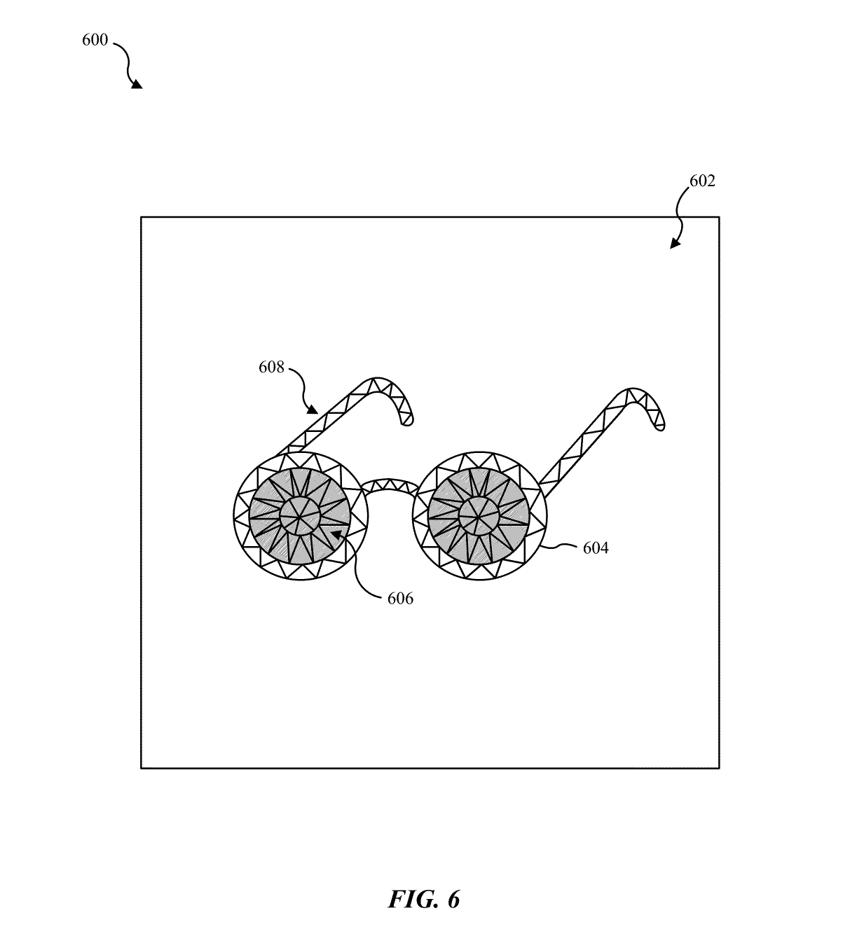

FIG. 6 illustrates an example arrangement 600 of a virtual 3-D space 602. As depicted, the 3-D space 602 of the example arrangement 600 may include a 3-D model of an object 604 (e.g., a pair of glasses). In some embodiments, the 3-D model of the object 604 may include a polygon mesh model of the object, which may be stored in the database 110 as polygon data 112. The polygon data 112 of the 3-D model of the object may include 3-D polygon mesh elements such as vertices, edges, faces, polygons, surfaces, and the like. As depicted, the 3-D model of the object 604 may include a first surface 606 and a second surface 608. For example, a 3-D model of a pair of glasses may include a portion of the polygon mesh corresponding to the lenses and a portion of the polygon mesh corresponding to the frames. Additionally, or alternatively, the 3-D model of the object 604 may include at least one texture map, which may be stored in the database 110 as texture map data 114.

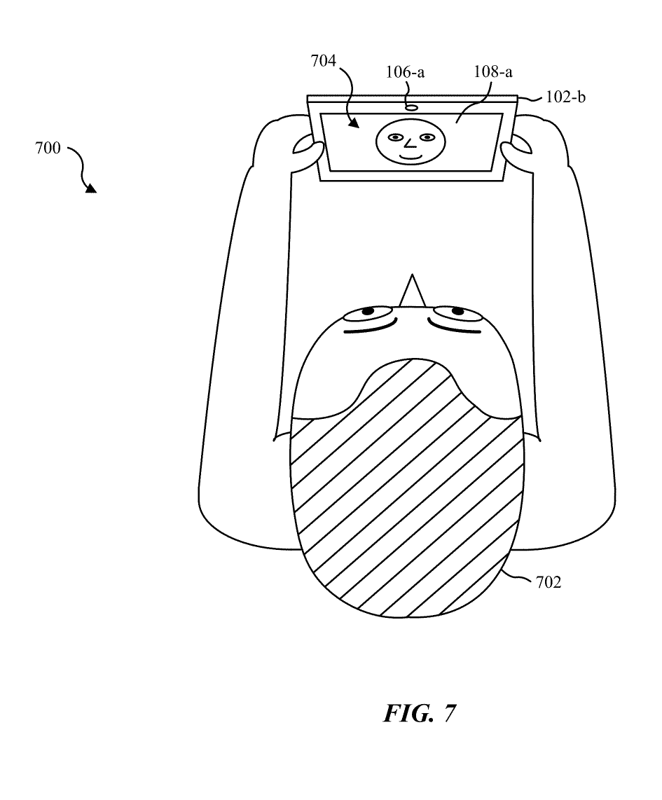

FIG. 7 illustrates an example arrangement 700 for capturing an image 704 of a user 702. In particular, the illustrated example arrangement 700 may include the user 702 holding a device 102-b. The device 102-b may include a camera 106-a and a display 108-a. The device 102-b, camera 106-a, and display 108-a may be examples of the device 102, camera 106, and display 108 depicted in FIGS. 1 and/or 2.

In one example, the user 702 holds the device 102-b at arm's length with the camera 106-a activated. The camera 106-a may capture an image 704 of the user and the display 108-a may show the captured image 704 to the user 702 (e.g., a real-time feedback image of the user). In some configurations, the camera 106-a may capture a video of the user 702. In some embodiments, the user may pan the device 102-b around the user's face to allow the camera 106-a to capture a video of the user from one side of the user's face to the other side of the user's face. Additionally, or alternatively, the user 702 may capture an image of other areas (e.g., arm, leg, torso, etc.). In one embodiment, the user may rotate the user's face relative to the camera 106-a. Although depicted as part of a mobile computing device, in some embodiments, the camera 106-a may include a camera (e.g., a “web cam”) attached to other types of computing devices (e.g., a laptop, desktop, etc.).

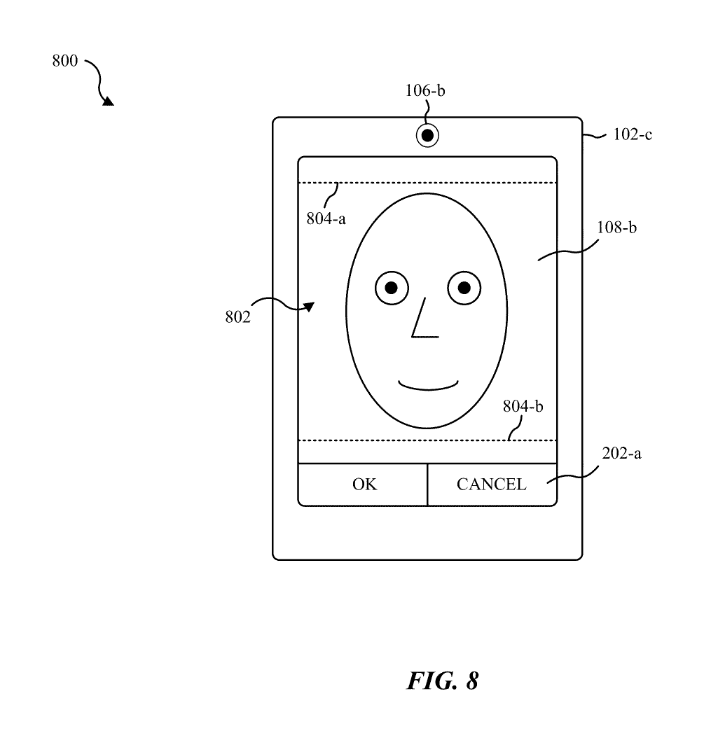

FIG. 8 is a diagram 800 illustrating an example of a device 102-c for capturing an image 802 of a user. The device 102-c may be one example of the device 102 illustrated in FIGS. 1 and/or 2. As depicted, the device 102-c may include a camera 106-b, a display 108-b, and an application 202-a. The camera 106-b, display 108-b, and application 202-a may each be an example of the respective camera 106, display 108, and application 202 illustrated in FIGS. 1 and/or 2.

In one embodiment, the user may operate the device 102-c. For example, the application 202-a may allow the user to interact with and/or operate the device 102-c. In one embodiment, the application 202-a may allow the user to capture an image 805 of the user. For example, the application 202-a may display the captured image 802 on the display 108-b. In some cases, the application 202-a may permit the user to accept or decline the image 802 that was captured.

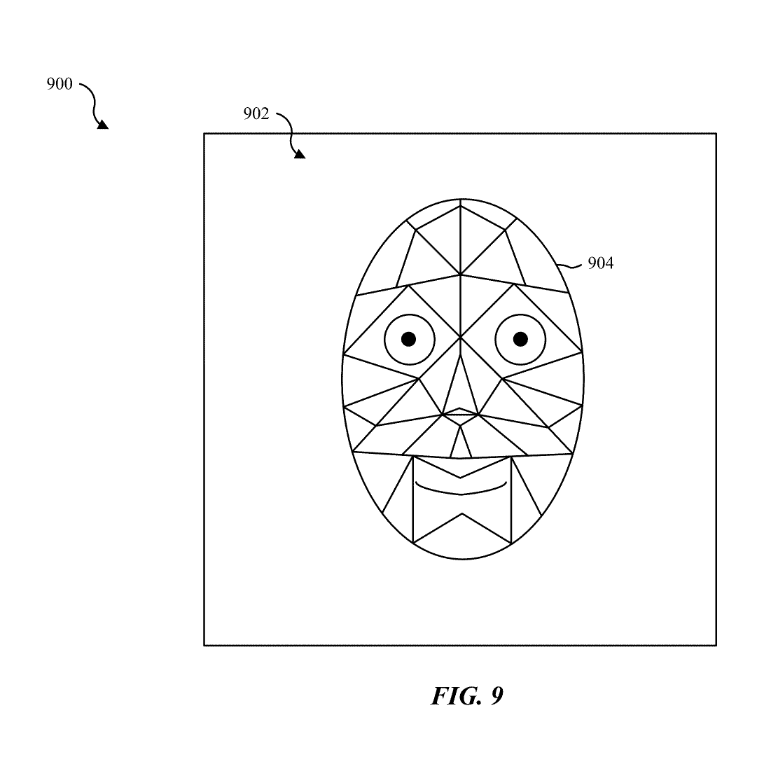

FIG. 9 illustrates an example arrangement 900 of a virtual 3-D space 902. As depicted, the 3-D space 902 of the example arrangement 900 may include a 3-D model of a user's head 904. In some embodiments, the 3-D model of the user's head 904 may include a polygon mesh model of the user's head, which may be stored in the database 110 as polygon data 112. The polygon data 112 of the 3-D model of the user may include 3-D polygon mesh elements such as vertices, edges, faces, polygons, surfaces, and the like. Additionally, or alternatively, the 3-D model of the user's head 904 may include at least one texture map, which may be stored in the database 110 as texture map data 114.

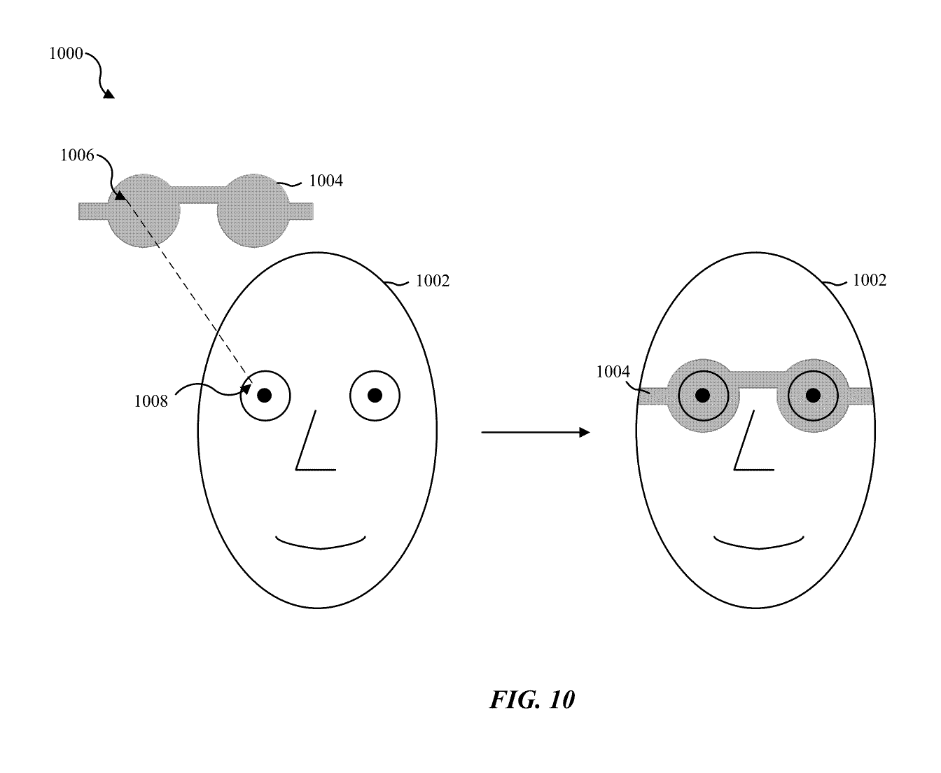

FIG. 10 illustrates another example arrangement of a virtual 3-D space 1000. In particular, the illustrated 3-D space 1000 includes an image of a user 1002 (e.g., a 2-D image of a user or a 3-D image of a user, etc.) and a depiction of a pair of glasses 1004 (a 2-D image of glasses or a 3-D image of glasses, etc.).

In one embodiment, the model generator 104 may map a point 1008 on the image of the user 1002 to a point 1006 on the glasses 1004. The model generator 104 may position the glasses 1004 on the user 1002 based on one or more matching points between the user 1002 and the glasses 1004.

In some configurations, the systems and methods described herein may be used to facilitate rendering a virtual try-on shopping experience. For example, a user may be presented with a pair of glasses (e.g., for the first time) via a rendered virtual try-on image that illustrates the pair of glasses on the user's face, thus, enabling a user to shop for glasses and to see how the user looks in the glasses (via the virtual try-on) simultaneously.

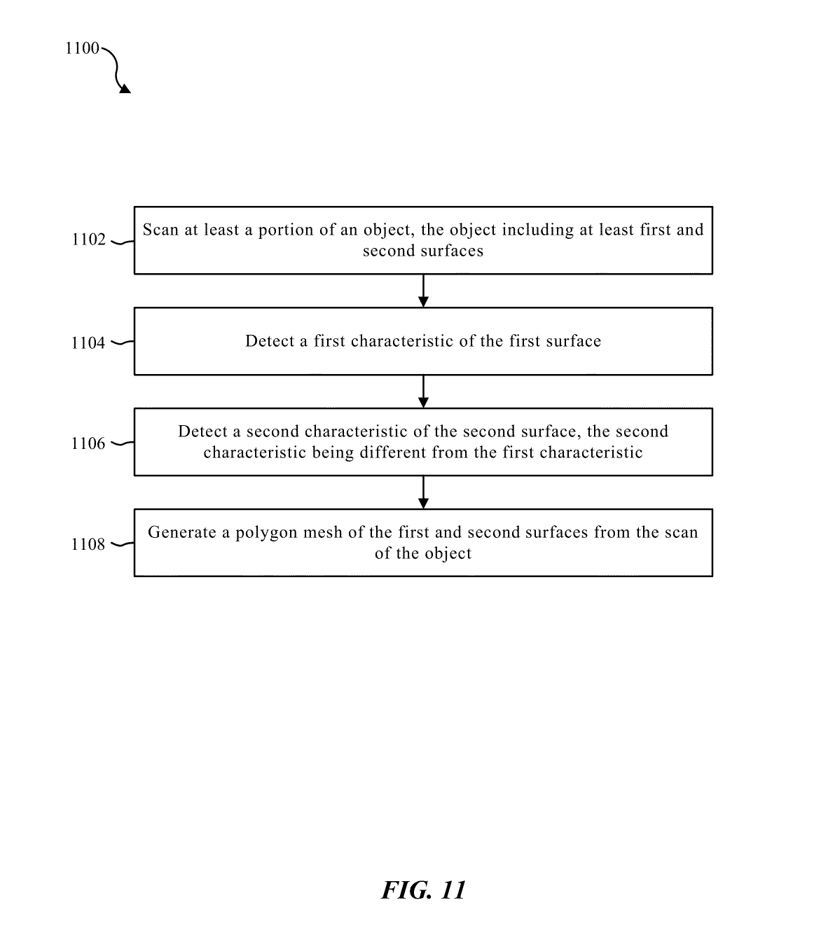

FIG. 11 is a flow diagram illustrating one embodiment of a method 1100 for generating a 3-D model of an object. In some configurations, the method 1100 may be implemented by the model generator 104 illustrated in FIGS. 1, 2, and/or 3. In some configurations, the method 1100 may be implemented by the application 202 illustrated in FIG. 2.

At block 1102, at least a portion of an object may be scanned. In some embodiments, the object may include at least first and second surfaces. At block 1104, a characteristic of the first surface may be detected. At block 1106, a characteristic of the second surface may be detected. As explained above, the object may include surfaces that are shiny, dull, matte, transparent, translucent, iridescent, opaque, metallic, smooth, and/or textured, etc. In some embodiments, the characteristic of the first surface may be different from the characteristic of the second surface. At block 1108, a polygon mesh of each surface of the object may be generated from the scan of the object.

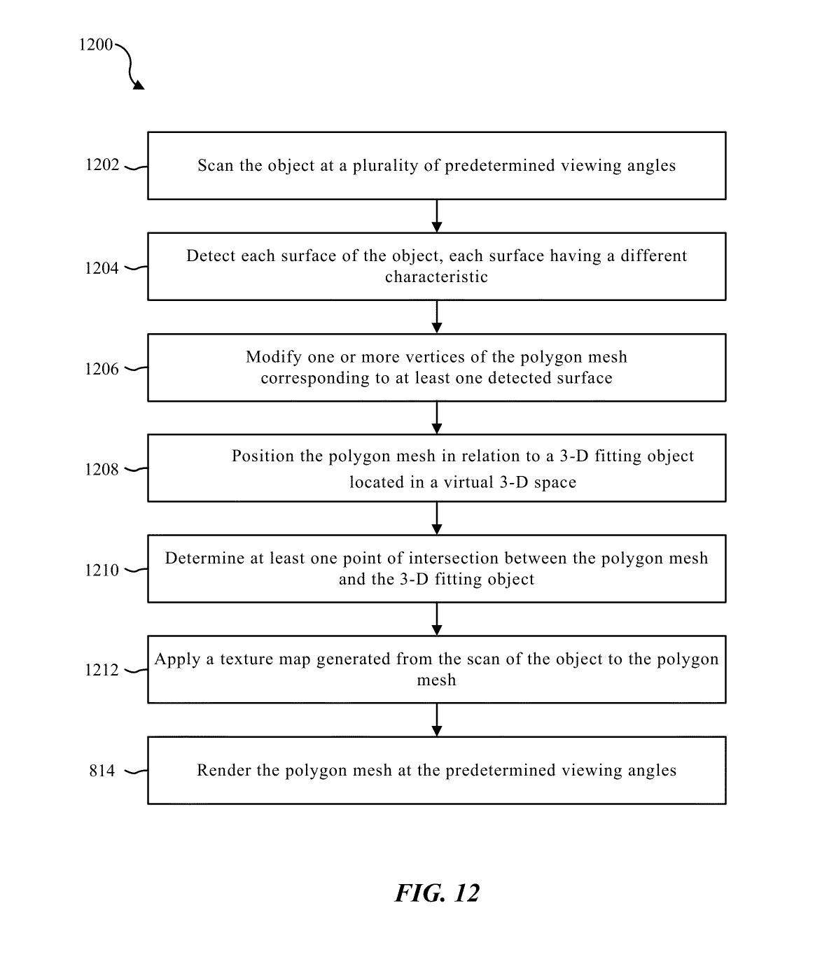

FIG. 12 is a flow diagram illustrating one embodiment of a method 1200 for rendering a polygon mesh. In some configurations, the method 1200 may be implemented by the model generator 104 illustrated in FIGS. 1, 2, and/or 3. In some configurations, the method 1200 may be implemented by the application 202 illustrated in FIG. 2.

At block 1202, an object may be scanned at a plurality of predetermined viewing angles. At block 1204, each surface of the object may be detected. In some configurations, each surface may have one or more different characteristics. At block 1206, one or more vertices of the polygon mesh corresponding to at least one detected surface may be modified. The vertices may be modified to improve the simulation of a detected characteristic of one or more surfaces of the scanned object. In some embodiments, one or more vertices may be added to the polygon mesh corresponding to one or more surfaces detected on the object. For example, one or more edge-loops may be added to the polygon mesh. Additionally, or alternatively, one or more vertices may be removed from the polygon mesh. For example, a decimation algorithm may be performed on one or more surfaces of the polygon mesh.

At block 1208, the polygon mesh may be positioned in relation to a 3-D fitting object located in a virtual 3-D space. In some embodiments, the 3-D fitting object may include a predetermined shape and size For example, a polygon mesh generated from scanning a pair of glasses may be positioned in relation to a 3-D model of a head in order to facilitate positioning and fitting the polygon mesh of the pair of glasses to a 3-D model of any user's head. At block 1210, at least one point of intersection may be determined between the polygon mesh and the 3-D fitting object

At block 1212, a texture map generated from the scan of the object may be applied to the polygon mesh. In some embodiments, the texture map may include a plurality of images depicting the first and second surfaces of the object. The texture map may map a 2-D coordinate (e.g., UV coordinates) of one of the plurality of images depicting the first and second surfaces of the object to a 3-D coordinate (e.g., XYZ coordinates) of the generated polygon mesh of the object. At block 1214, the polygon mesh may be rendered at the predetermined viewing angles. For example, a polygon mesh of a pair of glasses may be textured and rendered in relation to an image of a user in order to realistically simulate the user wearing the pair of glasses.

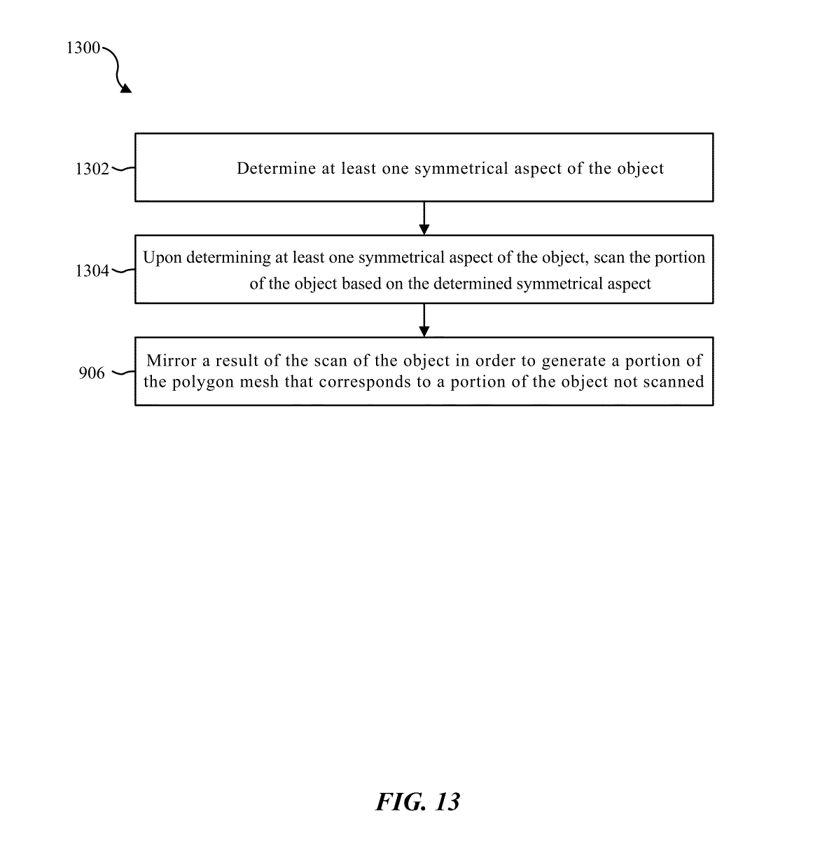

FIG. 13 is a flow diagram illustrating one embodiment of a method 1300 for scanning an object based on a detected symmetry of the object. In some configurations, the method 1300 may be implemented by the model generator 104 illustrated in FIGS. 1, 2, and/or 3. In some configurations, the method 1300 may be implemented by the application 202 illustrated in FIG. 2.

At block 1302, at least one symmetrical aspect of the object may be determined. Upon determining at least one symmetrical aspect of the object, at block 1304, the portion of the object may be scanned based on the determined symmetrical aspect. At block 1306, a result of the scan of the object may be mirrored in order to generate a portion of the polygon mesh that corresponds to a portion of the object not scanned.

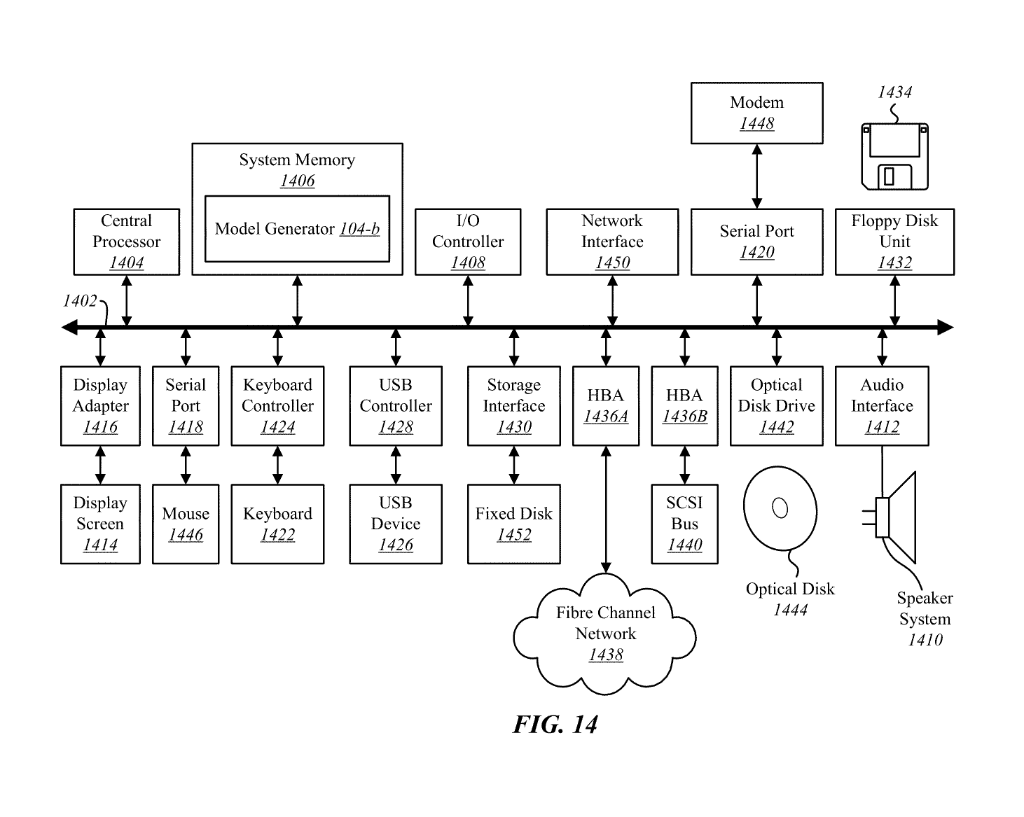

FIG. 14 depicts a block diagram of a computer system 1400 suitable for implementing the present systems and methods. The depicted computer system 1400 may be one example of a server 206 depicted in FIG. 2. Alternatively, the system 1400 may be one example of a device 102 depicted in FIGS. 1 and/or 2. Computer system 1400 includes a bus 1402 which interconnects major subsystems of computer system 1400, such as a central processor 1404, a system memory 1406 (typically RAM, but which may also include ROM, flash RAM, or the like), an input/output controller 1408, an external audio device, such as a speaker system 1410 via an audio output interface 1412, an external device, such as a display screen 1414 via display adapter 1416, serial ports 1418 and mouse 1446, a keyboard 1422 (interfaced with a keyboard controller 1424), multiple USB devices 1426 (interfaced with a USB controller 1428), a storage interface 1430, a host bus adapter (HBA) interface card 1436A operative to connect with a Fibre Channel network 1438, a host bus adapter (HBA) interface card 1436B operative to connect to a SCSI bus 1440, and an optical disk drive 1442 operative to receive an optical disk 1444. Also included are a mouse 1446 (or other point-and-click device, coupled to bus 1402 via serial port 1418), a modem 1448 (coupled to bus 1402 via serial port 1420), and a network interface 1450 (coupled directly to bus 1402).

Bus 1402 allows data communication between central processor 1404 and system memory 1406, which may include read-only memory (ROM) or flash memory, and/or random access memory (RAM), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a model generator 104-b to implement the present systems and methods may be stored within the system memory 1406. The model generator 104-b may be one example of the model generator 104 depicted in FIGS. 1, 2, and/or 3. Applications resident with computer system 1400 are generally stored on and accessed via a non-transitory computer readable medium, such as a hard disk drive (e.g., fixed disk 1452), an optical drive (e.g., optical drive 1442), or other storage medium. Additionally, applications can be in the form of electronic signals modulated in accordance with the application and data communication technology when accessed via network modem 1448 or interface 1450.

Storage interface 1430, as with the other storage interfaces of computer system 1400, can connect to a standard computer readable medium for storage and/or retrieval of information, such as a fixed disk drive 1452. Fixed disk drive 1452 may be a part of computer system 1400 or may be separate and accessed through other interface systems. Modem 1448 may provide a direct connection to a remote server via a telephone link or to the Internet via an internet service provider (ISP). Network interface 1450 may provide a direct connection to a remote server via a direct network link to the Internet via a POP (point of presence). Network interface 1450 may provide such connection using wireless techniques, including digital cellular telephone connection, Cellular Digital Packet Data (CDPD) connection, digital satellite data connection or the like.

Many other devices or subsystems may be connected in a similar manner (e.g., document scanners, digital cameras and so on). For example, the scanner 502 may connect to the computer system 1400 through the USB controller 1428, I/O controller 1408, network interface 1450, and/or other similar connections. Conversely, all of the devices shown in FIG. 14 need not be present to practice the present systems and methods. The devices and subsystems can be interconnected in different ways from that shown in FIG. 14. The operation of at least some of the computer system 1400 such as that shown in FIG. 14 is readily known in the art and is not discussed in detail in this application. Code to implement the present disclosure can be stored in a non-transitory computer-readable medium such as one or more of system memory 1406, fixed disk 1452, or optical disk 1444. The operating system provided on computer system 1400 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps may be performed in an order not illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for generating a three-dimensional (3-D) model of an object, the method comprising:
scanning at least a portion of an object, wherein the object includes at least first and second surfaces;
detecting an aspect of the first surface;
detecting an aspect of the second surface, the aspect of the second surface being different from the aspect of the first surface; and
generating a polygon mesh of the first and second surfaces from the scan of the object.

2. The method of claim 1, further comprising:
positioning the polygon mesh in relation to a 3-D fitting object in a virtual 3-D space, wherein the 3-D fitting object comprises a predetermined shape and size; and
determining at least one point of intersection between the polygon mesh and the 3-D fitting object.

3. The method of claim 1, further comprising:
modifying one or more vertices of the polygon mesh corresponding to the first surface to simulate the first surface.

4. The method of claim 3, wherein modifying one or more vertices of the polygon mesh corresponding to the first surface further comprises:
adding a plurality of vertices to at least a portion of the polygon mesh corresponding to the first surface.

5. The method of claim 1, further comprising:
performing a decimation algorithm on at least a portion of the polygon mesh corresponding to the second surface.

6. The method of claim 1, further comprising:
determining at least one symmetrical aspect of the object;
upon determining the symmetrical aspect of the object, scanning the portion of the object based on the determined symmetrical aspect; and
mirroring a result of the scan of the object in order to generate a portion of the polygon mesh that corresponds to a portion of the object not scanned.

7. The method of claim 1, further comprising:
applying a texture map generated from the scan of the object to the polygon mesh, wherein the texture map includes a plurality of images depicting the first and second surfaces of the object, and wherein the texture map maps a two-dimensional (2-D) coordinate of one of the plurality of images depicting the first and second surfaces of the object to a 3-D coordinate of the generated polygon mesh of the object.

8. The method of claim 1, wherein scanning at least a portion of the object further comprises:
scanning the object at a plurality of predetermined viewing angles.

9. The method of claim 8, further comprising:
rendering the polygon mesh at the predetermined viewing angles.

10. A computing device configured to generate a three-dimensional (3-D) model of an object, comprising:
a processor;
memory in electronic communication with the processor;
instructions stored in the memory, the instructions being executable by the processor to:
scan at least a portion of an object, wherein the object includes at least first and second surfaces;
detect an aspect of the first surface;
detect an aspect of the second surface, the aspect of the second surface being different from the aspect of the first surface; and
generate a polygon mesh of the first and second surfaces from the scan of the object.

11. The computing device of claim 10, wherein the instructions are executable by the processor to:
position the polygon mesh in relation to a 3-D fitting object in a virtual 3-D space, wherein the 3-D fitting object comprises a predetermined shape and size; and
determine at least one point of intersection between the polygon mesh and the 3-D fitting object.

12. The computing device of claim 10, wherein the instructions are executable by the processor to:
modify one or more vertices of the polygon mesh corresponding to the first surface to simulate the first surface.

13. The computing device of claim 12, wherein the instructions are executable by the processor to:
add a plurality of vertices to at least a portion of the polygon mesh corresponding to the first surface.

14. The computing device of claim 10, wherein the instructions are executable by the processor to:
perform a decimation algorithm on at least a portion of the polygon mesh corresponding to the second surface.

15. The computing device of claim 10, wherein the instructions are executable by the processor to:
determine at least one symmetrical aspect of the object;
upon determining the symmetrical aspect of the object, scan the portion of the object based on the determined symmetrical aspect; and
mirror a result of the scan of the object in order to generate a portion of the polygon mesh that corresponds to a portion of the object not scanned.

16. The computing device of claim 10, wherein the instructions are executable by the processor to:
apply a texture map generated from the scan of the object to the polygon mesh, wherein the texture map includes a plurality of images depicting the first and second surfaces of the object, and wherein the texture map maps a two-dimensional (2-D) coordinate of one of the plurality of images depicting the first and second surfaces of the object to a 3-D coordinate of the generated polygon mesh of the object.

17. The computing device of claim 10, wherein the instructions are executable by the processor to:
scan the object at a plurality of predetermined viewing angles.

18. The computing device of claim 17, wherein the instructions are executable by the processor to:
render the polygon mesh at the predetermined viewing angles.

19. A computer-program product for generating a three-dimensional (3-D) model of an object, the computer-program product comprising a non-transitory computer-readable medium storing instructions thereon, the instructions being executable by a processor to:
scan at least a portion of an object, wherein the object includes at least first and second surfaces;
detect an aspect of the first surface;
detect an aspect of the second surface, the aspect of the second surface being different from the aspect of the first surface; and
generate a polygon mesh of the first and second surfaces from the scan of the object.

20. The computer-program product of claim 19, wherein the instructions are executable by the processor to:
position the polygon mesh in relation to a 3-D fitting object in a virtual 3-D space, wherein the 3-D fitting object comprises a predetermined shape and size;
determine at least one point of intersection between the polygon mesh and the 3-D fitting object; and
render the polygon mesh at predetermined viewing angles.
